(19) United States
(12) Patent Application Publication
(10) Pub. No.: US 2026/0291579 A1
(43) Pub. Date: Sep. 24, 2026

(54) METHOD AND APPARATUS FOR DETERMINING PRECODING MATRIX IN MOBILE COMMUNICATIONS

(71) Applicant: MediaTek Singapore Pte. Ltd., Singapore (SG)

(72) Inventors: Sandeep BHAT, Bengaluru (IN); Kuan-Hung CHOU, Hsinchu City (TW); Chin-Kuo JAO, Hsinchu City (TW)

(73) Assignee: MediaTek Singapore Pte. Ltd., Singapore (SG)

(21) Appl. No.: 19/475,664

(22) PCT Filed: Dec. 13, 2024
(86) PCT No.: PCT/CN2024/139033

§ 371 Date: Oct. 15, 2025

(30) Foreign Application Priority Data
Dec. 14, 2023 (IN) 202321085479

(51) Int. Cl. H04B 7/06; H04L 27/26

(52) U.S. Cl. CPC H04B 7/0626; H04B 7/0639; H04B 7/0663; H04L 27/265

(57) ABSTRACT

Various solutions for determining precoding matrix with respect to an apparatus in mobile communications are disclosed. The apparatus may receive a plurality of channel state information reference signal (CSI-RS) resources. The apparatus may determine a precoding matrix indicator (PMI). The PMI may correspond to a precoding matrix W. The precoding matrix W may be a product of matrices W_{D} and W_{P}. The matrix W_{D} may be a block diagonal matrix diag{W₁, . . . , W_{Ng}}, and each block matrix Wₖ of the block diagonal matrix may be associated with one of the plurality of CSI-RS resources. The matrix W_{P} may be an inter-resource phase compensation matrix. The apparatus may transmit a CSI report including the PMI.

### CROSS REFERENCE TO RELATED PATENT APPLICATION(S)

The present disclosure is part of a non-provisional application claiming the priority benefit of India patent application No. 202321085479, filed 14 Dec. 2023, the content of which herein being incorporated by reference in its entirety.

### TECHNICAL FIELD

The present disclosure is generally related to mobile communications and, more particularly, to determining precoding matrix with respect to apparatus in mobile communications.

### BACKGROUND

Unless otherwise indicated herein, approaches described in this section are not prior art to the claims listed below and are not admitted as prior art by inclusion in this section.

In New Radio (NR) mobile communications, the use of large antenna arrays has become crucial for meeting the high data rate and capacity demands. With the developments of large antenna arrays, challenges arise in designing efficient precoding matrices that account for the unique spatial characteristics and phase discrepancies among antennas.

In conventional precoding matrix designs, simplifying assumptions may be made regarding the spatial distribution of antennas and the linearity of phase shifts between the antennas. More specifically, traditional precoding techniques assume planar wave propagation with uniform phase shifts, especially in far-field communication. However, these assumptions become inadequate as the number of antennas increases significantly and the communication distance decreases substantially, leading to performance degradation, especially in near-field communication at high frequencies.

For example, in some scenarios involving a large-scale antenna system in near-field communication, the spatial arrangement of the antennas causes non-uniform phase differences between antennas due to varying communication path lengths because, unlike in far-field communication where wavefronts are considered as planar, wavefronts are considered as spherical in near-field communication. Therefore, these non-uniform phase differences cannot be sufficiently corrected using conventional precoding matrix designed for far-field communication.

Accordingly, how to correct non-uniform phase differences appropriately becomes an important issue in the newly developed wireless communication network. Therefore, there is a need to provide proper schemes to correct non-uniform phase differences appropriately.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to determining precoding matrix with respect to apparatus in mobile communications.

In one aspect, a method may involve an apparatus receiving a plurality of channel state information reference signals (CSI-RSs) associated with a plurality of signal source groups. The method may further involve the apparatus determining a plurality of precoders and a plurality of phase compensations associated with the plurality of signal source groups based on the plurality of CSI-RSs. The method may further involve the apparatus transmitting the plurality of precoders and the plurality of phase compensations for determining a precoding matrix associated with a frequency block. The frequency block may be a subband or finer frequency granularity, so the frequency block size may be the subband size or finer frequency granularity size. The frequency block size may be indicated by a ratio of the subband size. The frequency block size may be configured by a gNB or reported by a UE. The UE could report the frequency block size in a CSI report, UE-Assistance Information (UAI), and other higher layer signalings.

In one aspect, a method may involve an apparatus transmitting a plurality of CSI-RSs associated with a plurality of signal source group for determining a plurality of precoders and a plurality of phase compensations associated with the plurality of signal source groups based on the plurality of CSI-RSs. The method may further involve the apparatus receiving the plurality of precoders and the plurality of phase compensations. The method may further involve the apparatus determining a precoding matrix based on the plurality of precoders and the plurality of phase compensations associated with a frequency block.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, via the transceiver, a plurality of CSI-RSs associated with a plurality of signal source groups. The processor may further perform operations comprising determining a plurality of precoders and a plurality of phase compensations associated with the plurality of signal source groups based on the plurality of CSI-RSs. The processor may further perform operations comprising transmitting, via the transceiver, the plurality of precoders and the plurality of phase compensations for determining a precoding matrix associated with a frequency block. The frequency block could be a subband or finer frequency granularity, so the frequency block size could be the subband size or finer frequency granularity size.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to determining precoding matrix with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may transmit a plurality of channel state information reference signals (CSI-RSs) to a user equipment (UE). After receiving the CSI-RSs, the UE may determine a precoding matrix indicator (PMI). The PMI may correspond to a precoding matrix W. The precoding matrix W may be a product of matrices W_{D} and W_{P} while W=W_{D}W_{P}. The matrix W_{P} may be a block diagonal matrix diag{W₁, . . . , W_{N}_{_{g}}}, and each block matrix Wₖ of the block diagonal matrix may be associated with one of the plurality of CSI-RS resources. The matrix W_{P} may be an inter-resource phase compensation matrix. Then, the UE may transmit a CSI report including the PMI to the network node.

Accordingly, the precoding matrix, determined based on the inter-resource phase compensation matrix, may more accurately represent the channel state between the network node and the UE.

More specifically, the network node may transmit the plurality of CSI-RSs to the UE. The CSI-RSs may be associated with a plurality of signal source groups. The plurality of signal source groups may be determined by the UE. After receiving the CSI-RSs, the UE may determine a plurality of precoders and a plurality of phase compensations associated with the plurality of signal source groups based on the plurality of CSI-RSs. Each phase compensation may be used for correcting phase shift associated with corresponding signal source group with respect to a reference signal source group.

Then, the UE may report the plurality of precoders and the plurality of phase compensations to the network node. After receiving the plurality of precoders and the plurality of phase compensations, the network node may reconstruct a precoding matrix based on the plurality of precoders and the plurality of phase compensations associated with a frequency block.

Accordingly, because the plurality of phase compensations may be used for correcting phase shifts associated with the signal source groups, the precoding matrix, determined based on the plurality of phase compensations, may more accurately represent the channel state between the network node and the UE.

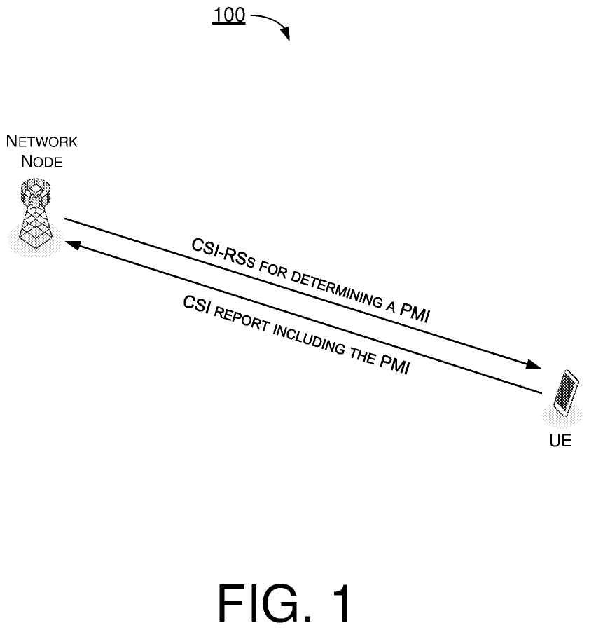

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some scenarios, the network node may communicate with the UE via a plurality of antennas. For example, the network node may be equipped with the plurality of antennas. For another example, the network node may be associated with (e.g., may include, control or communicatively connect with) a plurality of planes while each plane includes some of the plurality of antennas. For another example, the network node may be associated with (e.g., may include, control or communicatively connect with) a plurality of transmission-reception points (TRPs) while each TRP includes some of the plurality of antennas.

In some embodiments, the network node may transmit a plurality of CSI-RSs to the UE. The CSI-RSs may be transmitted from a plurality of CSI-RS ports which may be configured by the network node. After receiving the CSI-RSs, the UE may determine a plurality of signal source 20 groups based on the CSI-RSs transmitted from the plurality of CSI-RS ports. In some cases, the UE may determine CSI-RSs having similar channel properties as belonging to the same signal source group.

For the plurality of signal source groups, the UE may determine a plurality of precoders and a plurality of phase compensations based on the plurality of CSI-RSs. More specifically, the UE may determine the plurality of precoders and the plurality of phase compensations to co-phase phase shifts between the signal source groups. In other words, the UE may determine one precoder and one phase compensation for one signal source group, and each phase compensation may be used for correcting phase shift associated with corresponding signal source group.

Then, the UE may transmit the plurality of precoders and the plurality of phase compensations to the network node. After receiving the plurality of precoders and the plurality of phase compensations, the network node may determine a precoding matrix based on the plurality of precoders and the plurality of phase compensations associated with a frequency block.

Accordingly, because the plurality of phase compensations may be used for correcting phase shifts associated with the signal source groups, the precoding matrix(es), determined based on the plurality of phase compensations, may more accurately represent the channel states between the network node and the UE. More specifically, the phase shifts caused due to inter-signal source group communication path length differences, particularly evident in near-field communication, may be corrected by the plurality of phase compensations so that the precoding matrix(es) derived based on the plurality of phase compensations may more appropriately represent the channel states between the network node controlling the transmissions of CSI-RSs and the UE.

In some embodiments, a specific spatial domain (SD) basis vector may be introduced. In particular, a conventional, discrete Fourier transform (DFT) vector assumes uniform phase shift (i.e., consistent path length difference) among antenna elements. To accommodate non-uniform phase shifts, a candidate basis vector may be obtained by perturbing the phase on each element of the DFT vector independently as:

$$[ \begin{matrix}{e}^{j {ϕ}_{0}} & 0 & 0 & 0 & 0 \\ 0 & {e}^{j {ϕ}_{1}} & 0 & 0 & 0 \\ 0 & 0 & {e}^{j {ϕ}_{2}} & 0 & 0 \\ 0 & 0 & 0 & ⋱ & 0 \\ 0 & 0 & 0 & 0 & {e}^{j {ϕ}_{N - 1}}\end{matrix} ] [ \begin{matrix}1 \\ {e}^{- j \frac{2 π}{N} k \cdot 1} \\ {e}^{- j \frac{2 π}{N} k \cdot 2} \\ ⋮ \\ {e}^{- j \frac{2 π}{N} k \cdot ( N - 1 )}\end{matrix} ]$$

where, N represents the number of CSI-RS ports, the right matrix represents the DFT vector, and the left matrix, W_{P} represents the per-CSI-RS port phase shift which needs to be computed by the UE from downlink channel and reported to the network node.

Moreover, for higher N, computing and reporting per-CSI-RS port phase may cause significant overhead. Accordingly, as an approximation, the phases of groups of CSI-RS ports may be perturbed by independent phase shifts. The rationale for the approximation may be that a uniform phase shift (i.e., consistent path length difference) may still hold true within groups of antenna elements.

Therefore, the specific SD basis vector may be represented as:

$$[ \begin{matrix}{I}_{0} & & & & \\ & {e}^{j {ϕ}_{1}} {I}_{1} & & & \\ & & {e}^{j {ϕ}_{2}} {I}_{2} & & \\ & & & ⋱ & \\ & & & & {e}^{j {ϕ}_{{N}_{ℊ - 1}}} {I}_{{N}_{ℊ - 1}}\end{matrix} ] [ \begin{matrix}1 \\ {e}^{- j \frac{2 π}{N} k \cdot 1} \\ {e}^{- j \frac{2 π}{N} k \cdot 2} \\ ⋮ \\ {e}^{\text{-j} \frac{2 π}{N} k \cdot ( N - 1 )}\end{matrix} ]$$

where Iₚ is the identity matrix of dimension Nₚ×Nₚ, p=0, 1, . . . N_{g}−1, Nₚ represents the number of CSI-RS ports belonging to group p, and

$${Σ}_{p = 0}^{{N}_{ℊ - 1}} {N}_{p} = N ,$$

which represents the total number of CSI-RS ports. In an event that all groups include the same number of ports Nₚ=Nₚ∀p=0, 1, . . . N_{g}−1, then N_{P}N_{g}=N. N_{g} represents the number of CSI-RS port groups which may have uniform path length difference within each group. N_{g} may be determined by the UE from downlink channel measurement (e.g., CSI-RSs having similar channel properties may be determined as belonging to the same CSI-RS port group). A set of N_{g} values may be defined as, e.g., {1, 2, 4, 8, 16, 32, 64} for 128 CSI-RS ports. The UE may report N_{g} by an index from the set or by a 7-bit bitmap. In some cases, in an event that N_{g}=1, N_{P}=128, it may generalize to the far-field communication where all CSI-RS ports have uniform path length difference. In some cases, in an event that N_{g}=64, N_{P}=2, it may mean that groups of 2 ports have uniform path length difference. In some cases, the ability to determine N_{g} may depend on how fine propagation delays (i.e., path length differences) the UE may resolve.

In addition, frequency dependence of the specific SD basis vector may be introduced. In particular, channels of nearby resource blocks (RBs) may exhibit similar characteristics. Instead of reporting the phase of each individual RB, the report may indicate how different RBs share the same W_{D} report. The slope of the phase ramp may be reported rather than the actual phase in each RB. For example, when the total number of RBs in the channel bandwidth is N_{RB}, and the actual phase in RB N_{RB} is

$$\frac{2 π}{{N}_{R B}} k {n}_{R B} ,$$

the slope is

$$\frac{2 π}{{N}_{R B}} k ,$$

the reported quantity is simply k. In some cases, the frequency dependency of the SD basis may be typically common for all data layers, and therefore the report may be layer-common or may be layer-specific.

Accordingly, the overall precoding matrix structure in RB n=0, 1, . . . N_{RB}−1 may be represented as:

$$[ \begin{matrix}{I}_{0} & & & & \\ & {e}^{j {ϕ}_{1} [ n ]} {I}_{1} & & & \\ & & {e}^{j {ϕ}_{2} [ n ]} {I}_{2} & & \\ & & & ⋱ & \\ & & & & {e}^{j {ϕ}_{{N}_{ℊ - 1}} [ n ]} {I}_{{N}_{ℊ - 1}}\end{matrix} ] [ \begin{matrix}{W}_{0} [ n ] \\ {W}_{1} [ n ] \\ {W}_{2} [ n ] \\ ⋮ \\ {W}_{{N}_{ℊ - 1}} [ n ]\end{matrix} ]$$

where Wₖ[n], k=0, 1, . . . N_{g}−1 may be any precoding matrix (e.g., Type I codebook W₁ matrix defined in 3GPP specification) reported over a potentially lower frequency granularity such as a subband consisting of multiple RBs.

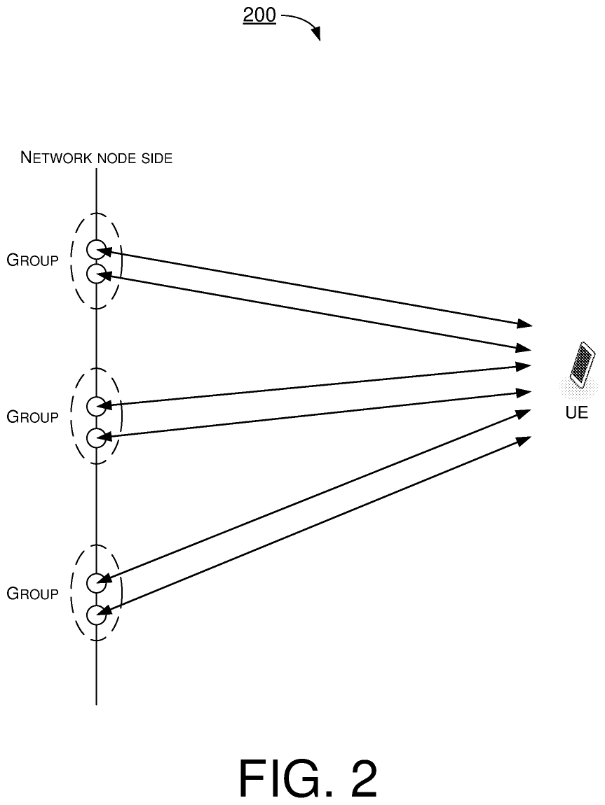

FIG. 2 illustrates an example scenario 200 under schemes in accordance with implementations of the present disclosure. In some embodiments, regarding multiple-panel transmission, multiple-TRP transmission, or general multiple CSI-RS resource (e.g., non-zero power (NZP) CSI-RS resource) transmission from the network node (i.e., from network node side illustrating the antennas of panels/TRPs associated with the network node), different panels, TRPs, or CSI-RS resources may have varying angles (i.e., spatial directions) for the UE due to the geometry of the deployment, significantly in near-field communication. Accordingly, lengths of paths between the network node (i.e., from network node side illustrating the antennas of panels/TRPs associated with the network node) and the UE may be significantly different for different transmit and receive antenna pairs of the network node and UE respectively. Therefore, compensating path length differences via relevant phase shifts may be necessary. In some cases, panel(s), TRP(s) or CSI-RS resource(s) having similar channel properties may be determined by UE as belonging to the same signal source group.

Accordingly, the overall precoding matrix W may be represented as:

$$W [ n ] = [ \begin{matrix}{W}_{i} [ n ] \\ {e}^{j {ϕ}_{2} [ n ]} {W}_{2} [ n ] \\ {e}^{j {ϕ}_{3} [ n ]} {W}_{3} [ n ] \\ ⋮ \\ {e}^{j {ϕ}_{{N}_{ℊ - 1}} [ n ]} {W}_{{N}_{ℊ}} [ n ]\end{matrix} ] = {W}_{D} [ n ] {W}_{p} [ n ] = [ \begin{matrix}{W}_{1} [ n ] & & & & \\ & {W}_{2} [ n ] & & & \\ & & {W}_{3} [ n ] & & \\ & & & ⋱ & \\ & & & & {W}_{{N}_{ℊ}} [ n ]\end{matrix} ] [ \begin{matrix}{I}_{1} \\ {e}^{j {ϕ}_{2} [ n ]} {I}_{2} \\ {e}^{j {ϕ}_{3} [ n ]} {I}_{3} \\ ⋮ \\ {e}^{j {ϕ}_{{N}_{ℊ}} [ n ]} {I}_{{N}_{ℊ}}\end{matrix} ]$$

where N_{g} represents the number of signal sources (e.g., panels, TRPs or NZP CSI-RS resources), n represents frequency dimension index (i.e., frequency block index), and Iₖ, k=1, 2, . . . N_{g} represents an identity matrix of dimension Nₖ×Nₖ, where Nₖ may represent the number of antenna ports in the k^{th} signal source. Each matrix Wₖ[n], k=1, 2, . . . N_{g} of the block diagonal matrix W_{D}[n] may represent a precoding matrix suited for the channel properties of signal source k=1, 2, . . . N_{g}. (e.g., Type I single panel precoding matrix defined in 3GPP specification). The matrix W_{P}[n] may consist of inter-signal source phase compensations φ₂, φ₃ . . . φ_{N}_{_{g}} with respect to the first source. These phase terms may compensate the path length differences of the signal sources 2, 3, . . . , N_{g} with respect to the path length of the first signal source to the UE. The matrix of phase compensations, W_{P}[n] may combine the precoding matrices of the individual signal sources, Wₖ[n], k=1, 2, . . . N_{g} into a single precoding matrix W[n] suited for the overall data transmission from multiple signal sources.

In some implementations, the network node may transmit a configuration indicating the number of a plurality of panels or the number of plurality of TRPs, while in some other cases, the UE may determine CSI-RS ports having similar channel properties as belonging to the same signal source group (i.e., UE determined CSI-RS port groups) and transmit the information of the number of signal source groups to the network as part of CSI feedback.

In some embodiments, the number of signal source groups and phase ramp slope may be optimally determined. In particular, the precoder matrix may be denoted as W[n]=W[n] (N_{g}, k₁, k₂, . . . k_{N}_{_{g}}₋₁) where N_{g} represents the number of signal source groups and kᵢ represents phase ramp slope of the i^{th} signal source group with respect to the 0^{th} signal source group. The optimum values of N_{g} and phase ramp slope k₁, k₂, . . . k_{N}_{_{g}}₋₁ may be determined by:

$${{max}_{{N}_{ℊ} ∈ 1 , 2 , 4 , 8 , 16 , 32}}_{{k}_{1} ∈ Φ , {k}_{2} ∈ Φ , …} {\sum }_{n = 1}^{{N}_{RB}} C ( H [ n ] W [ n ] ( {N}_{ℊ} , {k}_{1} , {k}_{2} , ⋯ {k}_{{N}_{ℊ - 1}} ) )$$

where C(⋅) denotes the multiple input multiple output (MIMO) channel capacity and Φ may be the phase ramp alphabet. For example,

$$Φ = \{ - \frac{{N}_{RB}}{2} + 1 , - \frac{{N}_{RB}}{2} + 2 , … 0 , 1 , … \frac{{N}_{RB}}{2} \} .$$

In some embodiments, network node configuration of spatial block size (i.e., the number of CSI-RS ports belonging to group p) N_{P} and frequency block size for the UE may be introduced. In particular, based on the above description, frequency block size B and spatial block size

$${N}_{P} = \frac{N}{{N}_{ℊ}}$$

may be determined such that:

$$\frac{1}{B} >> \frac{{r}^{( {N}_{P} - 1 )} - r}{c}$$

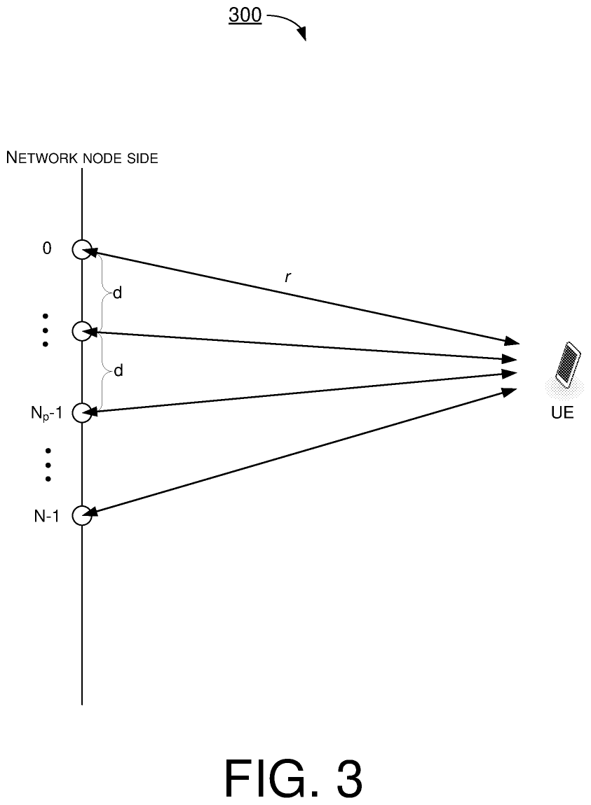

Based on FIG. 3 illustrating an example scenario 300 under schemes in accordance with implementations of the present disclosure, it may be found that:

$${r}^{( {N}_{P} - 1 )} - r = \sqrt{{r}^{2} + {N}_{P}^{2} {d}^{2}} - r = r \sqrt{( 1 + \frac{{N}_{P}^{2} {d}^{2}}{{r}^{2}} )} - r \approx r ( 1 + \frac{{N}_{P}^{2} {d}^{2}}{2 {r}^{2}} - 1 ) = \frac{{N}_{P}^{2} {d}^{2}}{2 r}$$

Therefore, the network node may configure B and N_{g} such that:

$$\frac{1}{B} >> \frac{{N}_{P}^{2} {d}^{2}}{2 r c} ⇒ B << \frac{2 r c}{{N}_{p}^{2} {d}^{2}} = \frac{2 {N}_{ℊ}^{2} r c}{{N}^{2} {d}^{2}}$$

In some cases, when the network node has a crude measure of r by pathloss, reference symbol received power (RSRP), etc. to estimate the distance r, the network node may configure the UE the values of spatial block and frequency block sizes.

It should be noted that, following paragraphs may illustrate some implementations of the aforementioned codebook designs (e.g., precoding matrices), and certain configurations and parameters (e.g., CodebookConfig, pmi-FormatIndicator, CSI-ReportConfig, codebookType, subbandSize, N₁, N₂, O₁, O₂, i₁, i₂, etc) may be defined in the 3GPP specification. Therefore, these configurations and parameters will not be further detailed in the present disclosure.

In some implementations, the aforementioned codebook designs (e.g., precoding matrices) may be used for downlink single-panel Type-I precoding matrix index (PMI) reporting, with the network node configured number of groups (e.g., CSI-RS port groups, antenna port groups) along with UE phase reporting. In particular, the network node may configure the UE a CSI-RS port configuration (N₁, N₂, O₁, O₂) in CodebookConfig, with the number of CSI-RS ports determined as P_{CSI-RS}=2N₁N₂.

Based on the configuration and received CSI-RSs from the network node, the UE may determine and transmit a plurality of first parameters, i₁ and a plurality of second parameters, i₂ associated with the precoder to the network node for determining the precoding matrix. More specifically, the UE may determine and report Type-I single panel precoder W₁[n] via transmitting the first and second parameters {i₁, i₂}, where the first parameter i₁ is associated with wideband channel property, and the second parameter i₂ is associated with wideband or subband channel property depending on pmi-FormatIndicator setting in CSI-ReportConfig.

Regarding configuration of codebookType type1, the network node may configure the UE a parameter for the size or the granularity of frequency blocks per PMI subband. In other words, the UE may receive a configuration including a parameter indicating the number of frequency blocks per PMI subband. The parameter may be introduced as numberOf-FreqBlocksPerPMI-Subband, numberOf-FreqBlocksPerPMI-Subband-r19, or numberOfPMI-SubbandsPerCQI-Subband, which may include values {1, 2, 4, 8, 16, 32}. The parameter may be used for determining the size of the frequency block in number of RBs, for reporting the phase rotation. For example, when subbandSize=8 and the parameter is selected as 4 from the values, the size of each frequency block is 8/4=2 RBs.

Regarding configuration of codebookType type1, the network node may configure the UE a parameter for the number of groups of antenna ports. The parameter may be introduced as nrOfAntennaPortGroups or nrOfAntennaPortGroups-r19, which may include values {1, 2, 4, 8, 16, 32}. The parameter may be used for determining the number of groups of antenna ports, N_{g} over each of which the plane wave (or uniform phase) assumption is valid, i.e., P_{CSI-RS}=N_{P}N_{g}, where Nₚ is the number of ports in one group.

Regarding inter-port-group phase compensations, a third parameter {i_{3,l}}, l=1, . . . N_{g}−1 associated with a frequency dependent property may be introduced. In particular, the UE may transmit a plurality of third parameters associated with the plurality of phase compensations to the network node for determining the precoding matrix. More specifically, the third parameters may be reported by the UE for each frequency block per PMI subband. Total number of frequency blocks N_{f} is equal to number of subbands multiplied by numberOf-FreqBlocksPerPMI-Subband-r19.

In some cases, the third parameter i_{3,l} may be an index from a set 0, 1, . . . M−1, such that each index may map to a complex phase. For example, regarding 16-phase shift keying (16-PSK, M=16) set, an index cₗ∈0, 1, . . . 15 maps to the phase

$${ϕ}_{l} = {e}^{j \frac{2 π {c}_{l}}{16}} .$$

However, it is not intended to limit the mapping. Other appropriate phase mappings may be applied.

Accordingly, after receiving the precoder and the phase compensation, the network node may determine a precoding matrix W[n] as:

$$[ \begin{matrix}{I}_{0} & & & & & \\ & & {e}^{j {ϕ}_{1} [ n ]} {I}_{1} & & & \\ & & & {e}^{j {ϕ}_{2} [ n ]} {I}_{2} & & \\ & & & & ⋱ & \\ & & & & & {e}^{j {ϕ}_{{N}_{g - 1} [ n ]}} {I}_{{N}_{g} - 1}\end{matrix} ] {W}_{1} [ n ]$$

where n=0, 1, . . . N_{f}−1 and Iₚ is an identity matrix of size N_{P}×N_{P}, p=0, . . . N_{g}−1.

In some implementations, the aforementioned codebook designs (e.g., precoding matrices) may be used for downlink single-panel Type-I PMI reporting, with the network node configured number of groups (e.g., port groups) along with UE phase ramp reporting. In particular, the network node may configure the UE a CSI-RS port configuration (N₁, N₂, O₁, O₂) in CodebookConfig, with the number of CSI-RS ports determined as P_{CSI-RS}=2N₁N₂.

Based on the configuration and received CSI-RSs from the network node, the UE may determine and transmit a plurality of first parameters, i₁ and a plurality of second parameters, i₂ associated with the precoder to the network node for determining the precoding matrix. More specifically, the UE may determine and report Type I single panel precoder W₁[n] via transmitting the first and second parameters {i₁, i₂}, where the first parameter i₁ is associated with wideband channel property, and the second parameter i₂ is associated with wideband or subband channel property depending on pmi-FormatIndicator setting in CSI-ReportConfig.

Regarding configuration of codebookType type1, the network node may configure the UE a parameter for the size or the granularity of frequency blocks per PMI subband. In other words, the UE may receive a configuration including a parameter indicating the number of frequency blocks per PMI subband. The parameter may be introduced as numberOf-FreqBlocksPerPMI-Subband, numberOf-FreqBlocksPerPMI-Subband-r19, or numberOfPMI-SubbandsPerCQI-Subband, which may include values {1, 2, 4, 8, 16, 32}. The parameter may be used for determining the size of the frequency block in number of RBs, for reporting the phase rotation. For example, when subbandSize=8 and the parameter is selected as 4 from the values, the size of each frequency block is 8/4=2 RBs.

Regarding configuration of codebookType type1, the network node may configure the UE a parameter for the number of groups of antenna ports. The parameter may be introduced as nrOfAntennaPortGroups or nrOfAntennaPortGroups-r19, which may include values {1, 2, 4, 8, 16, 32, 64}. The parameter may be used for determining the number of groups of antenna ports, N_{g} over each of which the plane wave (or uniform phase) assumption is valid, i.e., P_{CSI-RS}=N_{P}N_{g}, where Nₚ is the number of ports in one group.

Regarding phase compensations, third parameter {i_{3,l}}, l=1, . . . N_{g}−1 associated with a frequency dependent property may be introduced. In particular, the UE may transmit a plurality of third parameters associated with the plurality of phase compensations to the network node for determining the precoding matrix. More specifically, the third parameter i_{3,l} may be reported by the UE. The parameter i_{3,l} may be an index from a set [symbol] =0, 1, . . . N_{f}−1, where total number of frequency blocks N_{f} is equal to number of subbands multiplied by numberOf-FreqBlocksPerPMI-Subband-r19. In some cases, an index cₗ∈0, 1, . . . N_{f}−1 is used to obtain the phase shift in frequency band n as

$${ϕ}_{l} [ n ] = {e}^{j \frac{2 π n {c}_{l}}{{N}_{f}}} .$$

However, it is not intended to limit the content of the set. Other sets [symbol] containing integer/fractional index may be applied.

Accordingly, after receiving the precoder and the phase compensation, the network node may determine a precoding matrix W[n] as:

$$[ \begin{matrix}{I}_{0} & & & & & \\ & & {e}^{j {ϕ}_{1} [ n ]} {I}_{1} & & & \\ & & & {e}^{j {ϕ}_{2} [ n ]} {I}_{2} & & \\ & & & & ⋱ & \\ & & & & & {e}^{j {ϕ}_{{N}_{g - 1}} [ n ]} {I}_{{N}_{g} - 1}\end{matrix} ] {W}_{1} [ n ]$$

where n=0, 1, . . . N_{f}−1 and Iₚ is an identity matrix of size N_{P}×N_{P}, p=0, . . . N_{g}−1.

In some implementations, the aforementioned codebook designs (e.g., precoding matrixes) may be used for downlink single-panel Type-I PMI reporting, with the UE determined number of groups (e.g., CSI-RS port groups) along with UE phase reporting. In particular, the network node may configure the UE a CSI-RS port configuration (N₁, N₂, O₁, O₂) in CodebookConfig, with the number of CSI-RS ports determined as P_{CSI-RS}=2N₁N₂.

Based on the configuration and received CSI-RSs from the network node, the UE may determine and transmit a plurality of first parameters, i₁ and a plurality of second parameters, i₂ associated with the precoder to the network node for determining the precoding matrix. More specifically, the UE may determine and report Type I single panel precoder W₁[n] via transmitting the first and second parameters {i₁, i₂}, where the first parameter i₁ is associated with wideband channel property, and the second parameter i₂ is associated with wideband or subband channel property depending on pmi-FormatIndicator setting in CSI-ReportConfig.

Regarding configuration of codebookType type1, the network node may configure the UE a parameter for the size or the granularity of frequency blocks per PMI subband. In other words, the UE may receive a configuration including a parameter indicating the number of frequency blocks per PMI subband. The parameter may be introduced as numberOf-FreqBlocksPerPMI-Subband, numberOf-FreqBlocksPerPMI-Subband-r19, or numberOfPMI-SubbandsPerCQI-Subband, which may include values {1, 2, 4, 8, 16, 32}. The parameter may be used for determining the size of the frequency block in number of RBs, for reporting the phase rotation. For example, when subbandSize=8 and the parameter is selected as 4 from the values, the size of each frequency block is 8/4=2 RBs.

Regarding configuration of codebookType type1, the network node may configure the UE a parameter for the number of groups of antenna ports. The parameter may be introduced as nrOfAntennaPortGroups or nrOfAntennaPortGroups-r19, which may include values {1, 2, 4, 8, 16, 32, 64}. The parameter may be used for determining the number of groups of antenna ports, N_{g} over each of which the plane wave (or uniform phase) assumption is valid. In these implementations, the UE may report a preferred value

$${N}_{g}^{( 0 )}$$

for the number of antenna port groups, such that

$${P}_{CSI - RS} = {N}_{P} {N}_{g}^{( 0 )} ,$$

where N_{P} is the number of ports in one group

Regarding phase compensations, third parameter

$$\{ {i}_{3 , l} \} , l = 1 , … {N}_{g}^{( 0 )} - 1$$

associated with a frequency dependent property may be introduced. In particular, the UE may transmit a plurality of third parameters associated with the plurality of phase compensations to the network node for determining the precoding matrix. More specifically, the third parameter associated with configured frequency block size may be reported by the UE for each frequency block per PMI subband. Total number of frequency blocks N_{f} is equal to number of subbands multiplied by numberOf-FreqBlocksPerPMI-Subband-r19.

In some cases, the third parameter i_{3,l} may be an index from a set 0, 1, . . . M−1, such that each index may map to a complex phase. For example, regarding 16-PSK (M=16) set, an index cₗ∈0, 1, . . . 15 maps to the phase

$${ϕ}_{l} = {e}^{j \frac{2 π {c}_{l}}{16}} .$$

However, it is not intended to limit the mapping. Other appropriate phase mappings may be applied.

Accordingly, after receiving the precoder and the phase compensation, the network node may determine a precoding matrix W[n] as:

$$[ \begin{matrix}{I}_{0} & & & & & \\ & & {e}^{j {ϕ}_{1} [ n ]} {I}_{1} & & & \\ & & & {e}^{j {ϕ}_{2} [ n ]} {I}_{2} & & \\ & & & & ⋱ & \\ & & & & & {e}^{j {ϕ}_{{N}_{g - 1}^{( 0 )} [ n ]}} {I}_{{N}_{g}^{( 0 )} - 1}\end{matrix} ] {W}_{1} [ n ]$$

where n=0, 1, . . . N_{f}−1 and Iₚ is an identity matrix of size N_{P}×N_{P}, p=0, . . . N−1.

In some implementations, the aforementioned codebook designs (e.g., precoding matrices) may be used for downlink single-panel Type-I PMI reporting, with UE determined number of groups (e.g., CSI-RS port groups) along with UE phase ramp reporting. In particular, the network node may configure the UE a CSI-RS port configuration (N₁, N₂, O₁, O₂) in CodebookConfig, with the number of CSI-RS ports determined as P_{CSI-RS}=2N₁N₂.

Based on the configuration and received CSI-RSs from the network node, the UE may determine and transmit a plurality of first parameters, i₁ and a plurality of second parameters, i₂ associated with the precoder to the network node for determining the precoding matrix. More specifically, the UE may determine and report Type I single panel precoder W₁[n] via transmitting the first and second parameters {i₁, i₂}, where the first parameter i₁ is associated with wideband channel property, and the second parameter i₂ is associated with wideband or subband channel property depending on pmi-FormatIndicator setting in CSI-ReportConfig.

Regarding configuration of codebookType type1, the network node may configure the UE a parameter for the size or the granularity of frequency blocks per PMI subband. In other words, the UE may receive a configuration including a parameter indicating the number of frequency blocks per PMI subband. The parameter may be introduced as numberOf-FreqBlocksPerPMI-Subband, numberOf-FreqBlocksPerPMI-Subband-r19, or numberOfPMI-SubbandsPerCQI-Subband, which may include values {1, 2, 4, 8, 16, 32}. The parameter may be used for determining the size of the frequency block in number of RBs, for reporting the phase rotation. For example, when subbandSize=8 and the parameter is selected as 4 from the values, the size of each frequency block is 8/4=2 RBs.

Regarding configuration of codebookType type1, the network node may configure the UE a parameter for the number of groups of antenna ports. The parameter may be introduced as nrOfAntennaPortGroups or nrOfAntennaPortGroups-r19, which may include values {1, 2, 4, 8, 16, 32, 64}. The parameter may be used for determining the number of groups of antenna ports, N_{g} over each of which the plane wave (or uniform phase) assumption is valid. In these implementations, the UE may report a preferred value

$${N}_{g}^{( 0 )}$$

for the number of antenna port groups, such that

$${P}_{CSI - RS} = {N}_{P} {N}_{g}^{( 0 )} ,$$

where N_{P} is the number of ports in one group

Regarding phase compensations, third parameter

$$\{ {i}_{3 , l} \} , l = 1 , … {N}_{g}^{( 0 )} - 1$$

associated with a frequency dependent property may be introduced. In particular, the UE may transmit a plurality of third parameters associated with the plurality of phase compensations to the network node for determining the precoding matrix. More specifically, the third parameter i_{3,l} may be reported by the UE. The parameter i_{3,l} may be an index from a set [symbol] =0, 1, . . . N_{f}−1, where total number of frequency blocks N_{f} is equal to number of subbands multiplied by numberOf-FreqBlocksPerPMI-Subband-r19. In some cases, an index cₗ∈0, 1, . . . N_{f}−1 is used to obtain the phase shift in frequency band n as

$${ϕ}_{l} [ n ] = {e}^{j \frac{2 π n {c}_{l}}{{N}_{f}}} .$$

However, it is not intended to limit the content of the set. Other sets [symbol] containing integer/fractional index may be applied.

Accordingly, after receiving the precoder and the phase compensation, the network node may determine a precoding matrix W[n] as:

$$[ \begin{matrix}{I}_{0} & & & & & \\ & & {e}^{j {ϕ}_{1} [ n ]} {I}_{1} & & & \\ & & & {e}^{j {ϕ}_{2} [ n ]} {I}_{2} & & \\ & & & & ⋱ & \\ & & & & & {e}^{j {ϕ}_{{N}_{g - 1}} [ n ]} {I}_{{N}_{g}^{( 0 )} - 1}\end{matrix} ] {W}_{1} [ n ]$$

where n=0, 1, . . . N_{f}−1 and Iₚ is an identity matrix of size N_{P}×N_{P},

$$p = 0 , … {N}_{g}^{( 0 )} - 1 .$$

In some implementations, the aforementioned codebook designs (e.g., precoding matrices) may be used for downlink single-panel Type-I PMI reporting, with the network node configured number of groups (e.g., CSI-RS port groups) and different DFT beams per group along with UE phase reporting.

Regarding configuration of codebookType type1, the network node may configure the UE a parameter for the number of groups of antenna ports. The parameter may be introduced as nrOfAntennaPortGroups or nrOfAntennaPortGroups-r19, which may include values {1, 2, 4, 8, 16, 32, 64}. The parameter may indicate the number of groups of antenna ports, N_{g} over each of which the plane wave (or uniform phase) assumption may be valid.

For each value of N_{g}, there may be supported values of CSI-RS port configuration N₁, N₂, and the corresponding values of O₁, O₂. Based on the supported configurations, the network node may configure the UE CSI-RS port configuration (N₁, N₂) in CodebookConfig, with the number of CSI-RS ports determined as P_{CSI-RS}=2N_{g}N₁N₂.

Based on the configuration and received CSI-RSs from the network node, the UE may determine and transmit a plurality of first parameters i_{1,k}, k=1, . . . N_{g} and a plurality of second parameters i_{2,k}, k=1, . . . N_{g} associated with the precoders to the network node for determining the precoding matrix. More specifically, the UE may determine and report Type I single panel precoder Wₖ[n] via transmitting the first and second parameters {i_{1,k}, i_{2,k}} for each antenna port group k=1, . . . N_{g}. Each of the first parameter i_{1,k} is associated with wideband channel property, and each of the second i_{2,k} is associated with wideband or subband channel property depending on pmi-FormatIndicator setting in CSI-ReportConfig.

Regarding configuration of codebookType type1, the network node may configure the UE a parameter for the size or the granularity of frequency blocks per PMI subband. In other words, the UE may receive a configuration including a parameter indicating the number of frequency blocks per PMI subband. The parameter may be introduced as numberOf-FreqBlocksPerPMI-Subband, numberOf-FreqBlocksPerPMI-Subband-r19, or numberOfPMI-SubbandsPerCQI-Subband, which may include values {1, 2, 4, 8, 16, 32}. The parameter may be used for determining the size of the frequency block in number of RBs, for reporting the phase rotation. For example, when subbandSize=8 and the parameter is selected as 4 from the values, the size of each frequency block is 8/4=2 RBs.

Regarding phase compensations, third parameter {i_{3,k}}, k=2, . . . N_{g} associated with a frequency dependent property may be introduced. In particular, the UE may transmit a plurality of third parameters associated with the plurality of phase compensations to the network node for determining the precoding matrix. More specifically, the third parameter may be reported by the UE for each frequency block per PMI subband. Total number of frequency blocks N_{f} is equal to number of subbands multiplied by numberOf-FreqBlocksPerPMI-Subband-r19.

In some cases, the third parameter i_{3,k} may be an index from a set 0, 1, . . . M−1, such that each index may map to a complex phase. For example, regarding 16-phase shift keying (16-PSK, M=16) set, an index cₗ∈0, 1, . . . 15 maps to the phase

$${ϕ}_{l} = {e}^{j \frac{2 π {c}_{l}}{16}} .$$

However, it is not intended to limit the mapping. Other appropriate phase mappings may be applied.

Accordingly, after receiving the precoder and the phase compensation, the network node may determine a precoding matrix W[n] as:

$$[ \begin{matrix}{W}_{1} [ n ] \\ {e}^{j {ϕ}_{2} [ n ]} {W}_{2} [ n ] \\ {e}^{j {ϕ}_{3} [ n ]} {W}_{3} [ n ] \\ ⋮ \\ {e}^{j {ϕ}_{{N}_{g}} [ n ]} {W}_{{N}_{g}} [ n ]\end{matrix} ]$$

where n=0, 1, . . . N_{f}−1.

In some implementations, the aforementioned codebook designs (e.g., precoding matrices) may be used for downlink single-panel Type-I PMI reporting, with UE reported number of groups (e.g., port groups) along with UE phase reporting.

Regarding configuration of codebookType type1, the network node may configure the UE a parameter for the number of groups of antenna ports. The parameter may be introduced as nrOfAntennaPortGroups or nrOfAntennaPortGroups-r19, which may include values {1, 2, 4, 8, 16, 32, 64}. The parameter may indicate the number of groups of antenna ports, N_{g} over each of which the plane wave (or uniform phase) assumption may be valid.

For each value of N_{g}, there may be supported values of CSI-RS port configuration N₁, N₂, and the corresponding values of O₁, O₂. Based on the supported configurations, the network node may configure the UE CSI-RS port configuration (N₁, N₂) in CodebookConfig, with the number of CSI-RS ports determined as P_{CSI-RS}=2N_{g}N₁N₂. In these implementations, the UE may report a different value for the number of antenna port groups (i.e., signal source groups),

$${N}_{g}^{( 0 )}$$

such that

$${P}_{CSI - RS} = 2 {N}_{g}^{( 0 )} {N}_{1} {N}_{2}$$

where (N₁, N₂) is a valid supported value for the selected

$${N}_{g}^{( 0 )} .$$

For example, regarding the reporting format, it is supposed that the allowed values of antenna port groups, i.e., {1, 2, 4, 8, 16, 32, 64} are represented as a 7-bit bitmap, the position of 1 in the bitmap indicates the UE selected value

$${N}_{g}^{( 0 )} .$$

Based on the configuration and received CSI-RSs from the network node, the UE may determine and transmit a plurality of first parameters i_{1,k}, k=1, . . . N_{g} and a plurality of second parameters i_{2,k}, k=1, . . . N_{g} associated with precoders to the network node for determining the precoding matrix. More specifically, the UE may determine and report Type I single panel precoder Wₖ[n] via transmitting the first and second parameters {i_{1,k}, i_{2,k}} for each antenna port group

$$k = 1 , … {N}_{g}^{( 0 )} .$$

Each of the first parameter i_{1,k} is associated with wideband channel property, and each of the second parameter i_{2,k} is associated with wideband or subband channel property depending on pmi-FormatIndicator setting in CSI-ReportConfig.

Regarding configuration of codebookType type1, the network node may configure the UE a parameter for the size or the granularity of frequency blocks per PMI subband. In other words, the UE may receive a configuration including a parameter indicating the number of frequency blocks per PMI subband. The parameter may be introduced as numberOf-FreqBlocksPerPMI-Subband, numberOf-FreqBlocksPerPMI-Subband-r19, or numberOfPMI-SubbandsPerCQI-Subband, which may include values {1, 2, 4, 8, 16, 32}. The parameter may be used for determining the size of the frequency block in number of RBs, for reporting the phase rotation. For example, when subbandSize=8 and the parameter is selected as 4 from the values, the size of each frequency block is 8/4=2 RBs.

Regarding phase compensations, third parameter

$$\{ {i}_{3 , k} \} , k = 2 , … {N}_{g}^{( 0 )}$$

associated with a frequency dependent property may be introduced. In particular, the UE may transmit a plurality of third parameters associated with the plurality of phase compensations to the network node for determining the precoding matrix. More specifically, the parameter may be reported by the UE for each frequency block per PMI subband. Total number of frequency blocks N_{f} is equal to number of subbands multiplied by numberOf-FreqBlocksPerPMI-Subband-r19.

In some cases, the third parameter i_{3,l} may be an index from a set 0, 1, . . . M−1, such that each index may map to a complex phase. For example, regarding 16-phase shift keying (16-PSK, M=16) set, an index cₗ∈0, 1, . . . 15 maps to the phase

$${ϕ}_{l} = {e}^{j \frac{2 π {c}_{l}}{16}} .$$

However, it is not intended to limit the mapping. Other appropriate phase mappings may be applied.

Accordingly, after receiving the precoder and the phase compensation, the network node may determine a precoding matrix W[n] as:

$$[ \begin{matrix}{W}_{1} [ n ] \\ {e}^{j {ϕ}_{2} [ n ]} {W}_{2} [ n ] \\ {e}^{j {ϕ}_{3} [ n ]} {W}_{3} [ n ] \\ ⋮ \\ {e}^{j {ϕ}_{{N}_{g}} [ n ]} {W}_{{N}_{g}^{( 0 )}} [ n ]\end{matrix} ]$$

where n=0, 1, . . . N_{f}−1.

In some implementations, the aforementioned codebook designs (e.g., precoding matrices) may be used for downlink multi-panel Type-I PMI reporting. In particular, the network node may configure the UE CSI-RS port configuration including values of N_{g} (i.e., the number of panels), N₁, N₂ (the number of CSI-RS ports per panel in the horizontal and vertical domains, respectively) in CodebookConfig, with the total number of CSI-RS ports across the multiple panels determined as P_{CSI-RS}=2N_{g}N₁N₂, where the factor 2 may represent the dual polarized antenna ports of the network node For each value of N_{g}, there may be supported values of CSI-RS port configuration N₁, N₂, and the corresponding values of DFT basis oversampling factors O₁, O₂. In these implementations, it is also possible that the UE may report a preferred value Na for the number of panels (i.e., antenna port groups or signal source groups) and the corresponding precoding matrices.

Based on the configuration and received CSI-RSs from the network node, the UE may determine and transmit a plurality of first parameters and a plurality of second parameters associated with the per-panel or per-signal source precoders to the network node for determining the overall precoding matrix. More specifically, the UE may determine and report Type I single panel precoding matrix Wₖ[n], k=1, 2, . . . N_{g} via transmitting the first and second parameters {i_{1,k}, i_{2,k}} for each panel or signal source group k=1, 2, . . . N_{g}. Each of the first parameter i_{1,k} may further consist of two or more parameters of the form i_{1,1,k}, i_{1,2,k}, i_{1,3,k}, where i_{1,1,k}, i_{1,2,k} determine the horizontal and vertical indices of a first DFT basis vector and i_{1,3,k} determines the index of a second DFT basis vector with respect to the first DFT basis vector associated with the Type I single panel precoding matrix Wₖ[n]. Each of the second parameter i_{2,k} may determine the index of a phase term used to combine the DFT basis vectors corresponding to two antenna polarizations within the panel or signal source group k=1, 2 . . . N_{g}. Each of the first parameter i_{1,k} may be associated with the wideband channel property, and each of the second parameter i_{2,k} may be associated with the wideband or subband channel property depending on pmi-FormatIndicator setting in CSI-ReportConfig.

Regarding configuration of codebookType type1, the network node may configure the UE a parameter for the size or the granularity of frequency blocks per subband. In other words, the UE may receive a configuration including a parameter indicating the number of frequency blocks per PMI subband. The parameter may be introduced as numberOf-FreqBlocksPerPMI-Subband, numberOf-FreqBlocksPerPMI-Subband-r19, or numberOfPMI-SubbandsPerCQI-Subband, which may include values {1, 2, 4, 8, 16, 32}. The parameter may be used for determining the size of the frequency block in number of RBs, for reporting the phase compensation terms for the second, third, and further panels or signal source groups with respect to the first panel or signal source group. For example, when subbandSize=8 and the parameter is selected as 4 from the values, the size of each frequency block is 8/4=2 RBs.

Regarding phase compensation terms for the second, third, and further panels or signal source groups with respect to the first panel or signal source group, a third parameter, e. g., {i_{3,k}}, k=2, . . . N_{g} associated with a frequency dependent property may be introduced. In particular, the UE may transmit a plurality of third parameters associated with the plurality of phase compensations to the network node for combining the individual precoding matrices Wₖ[n], k=1, 2, . . . N_{g} into an overall precoding matrix W[n]. More specifically, the third parameter may be reported by the UE according to the configured frequency granularity, for example, wideband, per subband or for each frequency block per subband.

In some cases, the third parameter i_{3,k}, k=2, 3, . . . N_{g} may be an index from a set 0, 1, . . . M−1, such that each index may map to a complex phase. For example, regarding 16-phase shift keying (16-PSK, M=16) set, an index cₗ∈0, 1, . . . 15 maps to the phase

$${ϕ}_{l} = {e}^{j \frac{2 π {c}_{l}}{16}} .$$

However, it is not intended to limit the mapping. Other appropriate phase mappings may be applied.

Accordingly, after receiving the individual precoders and the phase compensations, the network node may determine the overall multi-panel precoding matrix W[n] as:

$$[ \begin{matrix}{W}_{1} [ n ] \\ {e}^{j {ϕ}_{2} [ n ]} {W}_{2} [ n ] \\ {e}^{j {ϕ}_{3} [ n ]} {W}_{3} [ n ] \\ ⋮ \\ {e}^{j {ϕ}_{{N}_{g}} [ n ]} {W}_{{N}_{g}} [ n ]\end{matrix} ]$$

where n=0, 1, . . . N_{f}−1.

In some implementations, the aforementioned codebook designs (e.g., precoding matrices) may be used for downlink multiple CSI-RS resources (e.g., co-located or geographically distant multi-TRP) Type I PMI reporting, with UE phase reporting. In particular, the network node may configure the UE N_{TRP}∈{1, 2, 3, 4} CSI-RS resources. The network node may configure the UE CSI-RS port configuration (N₁, N₂, O₁, O₂) in CodebookConfig, which may be the same or different for different CSI-RS resources. In these implementations, the UE may report a preferred value

$${N}_{g}^{( 0 )}$$

for the number of TRPs (i.e., antenna port groups or signal source groups).

Based on the configuration and received CSI-RSs from the network node, the UE may determine and transmit a plurality of first parameters and a plurality of second parameters associated with the per-TRP precoders to the network node for determining the overall precoding matrix. More specifically, the UE may determine and report Type I single panel precoding matrix Wₖ[n], k=1, 2, . . . N_{TRP} via transmitting the first and second parameters {i_{1,k}, i_{2,k}} for each TRP or antenna port group k=1, . . . N_{TRP}. Each of the first parameter i_{1,k} is associated with the wideband channel property, and each of the second parameter i_{2,k} is associated with wideband or subband channel property depending on pmi-FormatIndicator setting in CSI-ReportConfig.

Regarding configuration of codebookType type1, the network node may configure the UE a parameter for the size or the granularity of frequency blocks per PMI subband. In other words, the UE may receive a configuration including a parameter indicating the number of frequency blocks per PMI subband. The parameter may be introduced as numberOf-FreqBlocksPerPMI-Subband, numberOf-FreqBlocksPerPMI-Subband-r19, or numberOfPMI-SubbandsPerCQI-Subband, which may include values {1, 2, 4, 8, 16, 32}. The parameter may be used for determining the size of the frequency block in number of RBs, for reporting the phase rotation. For example, when subbandSize=8 and the parameter is selected as 4 from the values, the size of each frequency block is 8/4=2 RBs.

Regarding phase compensations, a parameter {i_{3,k}}, k=2, . . . N_{TRP} may be introduced. In particular, the UE may transmit a plurality of third parameters associated with the plurality of phase compensations to the network node for determining the precoding matrix. More specifically, the third parameter may be reported by the UE for each frequency block per PMI subband.

In some cases, the third parameter i_{3,k} may be an index from a set 0, 1, . . . M−1, such that each index may map to a complex phase. For example, regarding 16-phase shift keying (16-PSK, M=16) set, an index cₗ∈0, 1, . . . 15 maps to the phase

$$[ \begin{matrix}{W}_{1} [ n ] \\ {e}^{j {ϕ}_{2} [ n ]} {W}_{2} [ n ] \\ {e}^{j {ϕ}_{3} [ n ]} {W}_{3} [ n ] \\ ⋮ \\ {e}^{j {ϕ}_{{N}_{TRP}} [ n ]} {W}_{{N}_{TRP}} [ n ]\end{matrix} ]$$

However, it is not intended to limit the mapping. Other appropriate phase mappings may be applied.

Accordingly, after receiving the precoder and the phase compensation, the network node may determine a precoding matrix W[n] as:

$${ϕ}_{l} = {e}^{j \frac{2 π {c}_{l}}{16}} .$$

where n=0, 1, . . . N_{f}−1.

### Illustrative Implementations

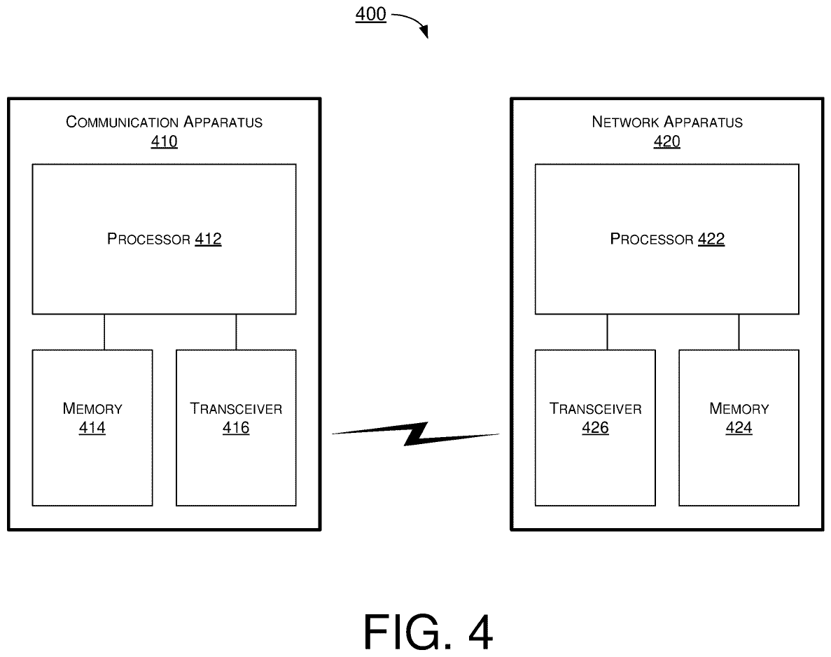

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to determining precoding matrix with respect to UE and network apparatus in mobile communications, including scenarios/schemes described above as well as processes 500 and 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router or a gateway. For instance, network apparatus 420 may be implemented in an eNodeB in an LTE network, in a gNB in a 5G/NR, IoT, NB-IoT or IIoT network or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including determining precoding matrix in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In other words, processor 412 may transceive the data such as configuration, message, signal, information, indicator, etc. via transceiver 416. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In other words, processor 422 may transceive the data such as configuration, message, signal, information, indicator, etc. via transceiver 426. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

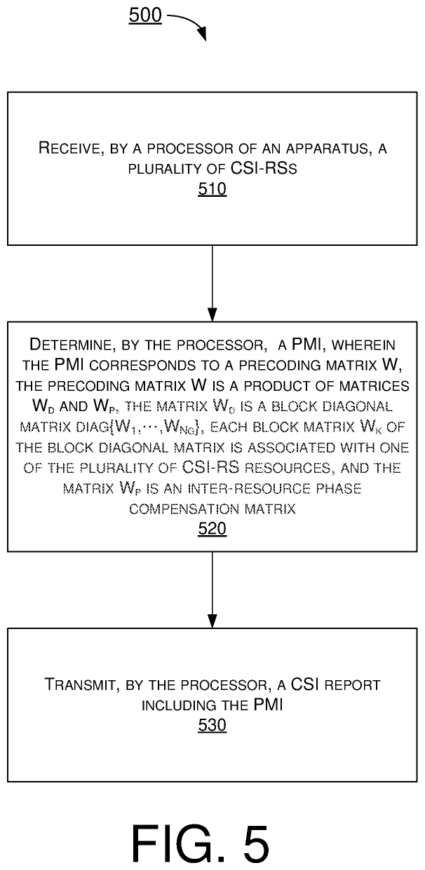

FIG. 5 illustrates an example process 500 in accordance with an implementation of the present disclosure. Process 500 may be an example implementation of above scenarios/schemes, whether partially or completely, with respect to determining precoding matrix of the present disclosure. Process 500 may represent an aspect of implementation of features of communication apparatus 410. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At block 510, process 500 may involve processor 412 of communication apparatus 410 receiving a plurality of CSI-RSs resources. Process 500 may proceed from block 510 to block 520.

At block 520, process 500 may involve processor 412 of communication apparatus 410 determining a PMI. The PMI may correspond to a precoding matrix W. The precoding matrix W may be a product of matrices W_{D} and W_{P}. The matrix W_{D} may be a block diagonal matrix diag{W₁, . . . , W_{N}_{_{g}}}, and each block matrix Wₖ of the block diagonal matrix may be associated with one of the plurality of CSI-RS resources. The matrix W_{P} may be an inter-resource phase compensation matrix. Process 500 may proceed from block 520 to block 530.

At block 520, process 500 may involve processor 412 of communication apparatus 410 transmitting a CSI report including the PMI.

In some implementations, the PMI may include a plurality of first parameters and a plurality of second parameters, associated with the plurality of CSI-RS resources respectively, to indicate the matrix Wₖ. The first parameters may indicate DFT indices of selected SD bases of the matrix Wₖ. The second parameters may indicate inter-polarization co-phase information of the matrix Wₖ. The first parameters and second parameters may be determined respectively for the plurality of CSI-RS resources.

In some implementations, the PMI may include a plurality of third parameters. The matrix W_{P} matrix may consist of a plurality of inter-resource phase terms. The plurality of third parameters may be independently determined to indicate the plurality of inter-resource phase terms with respect to a first resource of the plurality of CSI-RS resources.

In some implementations, the plurality of first parameters may be associated with wideband property of the PMI. The plurality of second parameters may be associated with wideband property of the PMI or subband property of the PMI. The plurality of third parameters may be associated with wideband property of the PMI or subband property of the PMI.

In some implementations, process 500 may involve processor 412 of communication apparatus 410 transmitting a size of a frequency block for determining the plurality of second parameters or the plurality of third parameters for subband property of the PMI.

In some implementations, the plurality CSI-RS resources may be associated with a plurality of TRPs, a plurality of antenna panels, or a plurality of antenna port groups.

In some implementations, process 500 may involve processor 412 of communication apparatus 410 transmitting a number of signal source groups N_{g}. Each signal source group may be associated with at least one port of the plurality of CSI-RS resources for determining the matrix W_{D}.

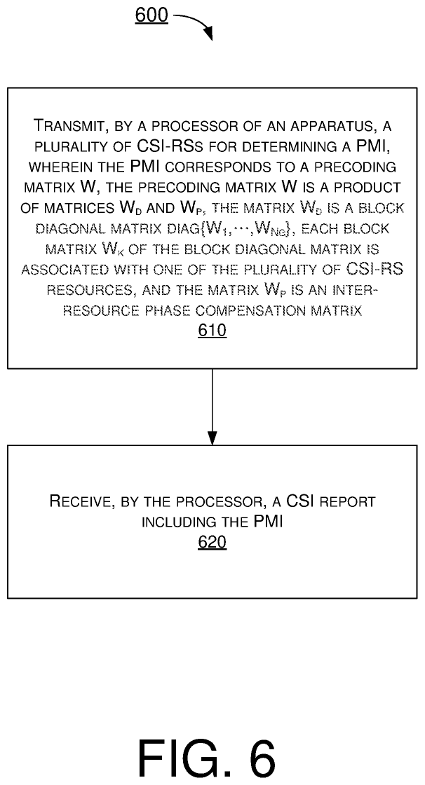

FIG. 6 illustrates an example process 600 in accordance with an implementation of the present disclosure. Process 600 may be an example implementation of above scenarios/schemes, whether partially or completely, with respect to determining precoding matrix of the present disclosure. Process 600 may represent an aspect of implementation of features of network apparatus 420. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 420 or any suitable network device or machine type devices. Solely for illustrative purposes and without limitation, process 600 is described below in the context of network apparatus 420. Process 600 may begin at block 610.

At block 610, process 600 may involve processor 422 of network apparatus 420 transmitting a plurality of CSI-RS resources for determining a PMI. The PMI may correspond to a precoding matrix W. The precoding matrix W may be a product of matrices W_{D} and W_{P}. The matrix W_{D} may be a block diagonal matrix diag{W₁, . . . , W_{N}_{_{g}}}, and each block matrix Wₖ of the block diagonal matrix may be associated with one of the plurality of CSI-RS resources. The matrix W_{P} may be an inter-resource phase compensation matrix. Process 600 may proceed from block 610 to block 620.

At block 620, process 600 may involve processor 422 of network apparatus 420 receiving a CSI report including the PMI.

In some implementations, the PMI may include comprise a plurality of first parameters and a plurality of second parameters, associated with the plurality of CSI-RS resources respectively, to indicate the matrix Wₖ. The first parameters may indicate DFT indices of selected SD bases of the matrix Wₖ. The second parameters may indicate inter-polarization co-phase information of the matrix Wₖ. The first parameters and second parameters may be determined respectively for the plurality of CSI-RS resources.

In some implementations, the PMI may include a plurality of third parameters. The matrix W_{P} matrix may consist of a plurality of inter-resource phase terms. The plurality of third parameters may be independently determined to indicate the plurality of inter-resource phase terms with respect to a first resource of the plurality of CSI-RS resources.

In some implementations, the plurality of first parameters may be associated with wideband property of the PMI. The plurality of second parameters may be associated with wideband property of the PMI or subband property of the PMI. The plurality of third parameters may be associated with wideband property of the PMI or subband property of the PMI.

In some implementations, process 600 may involve processor 422 of network apparatus 420 receiving a size of a frequency block for determining the plurality of second parameters or the plurality of third parameters for subband property of the PMI.

In some implementations, the plurality CSI-RS resources may be associated with a plurality of TRPs, a plurality of antenna panels, or a plurality of antenna port groups.

In some implementations, process 600 may involve processor 422 of network apparatus 420 receiving a number of signal source groups N_{g}. Each signal source group may be associated with at least one port of the plurality of CSI-RS resources for determining the matrix W_{D}.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a plurality of channel state information reference signal (CSI-RS) resources;
determining, by the processor, a precoding matrix indicator (PMI), wherein the PMI corresponds to a precoding matrix W, the precoding matrix W is a product of matrices W_{D} and W_{P}, the matrix W_{D} is a block diagonal matrix diag{W₁, . . . , W_{N}_{_{g}}}, each block matrix Wₖ of the block diagonal matrix is associated with one of the plurality of CSI-RS resources, and the matrix W_{P} is an inter-resource phase compensation matrix; and
transmitting, by the processor, a CSI report including the PMI.

2. The method of claim 1, wherein the PMI further comprises a plurality of first parameters and a plurality of second parameters, associated with the plurality of CSI-RS resources respectively, to indicate the matrix Wₖ, the first parameters indicate Discrete Fourier Transform (DFT) indices of selected spatial domain (SD) bases of the matrix Wₖ, the second parameters indicate inter-polarization co-phase information of the matrix Wₖ, and the first parameters and second parameters are determined respectively for the plurality of CSI-RS resources.

3. The method of claim 2, wherein the PMI further comprises a plurality of third parameters, the matrix W_{P} matrix consists of a plurality of inter-resource phase terms, the plurality of third parameters are independently determined to indicate the plurality of inter-resource phase terms with respect to a first resource of the plurality of CSI-RS resources.

4. The method of claim 3, wherein the plurality of first parameters are associated with wideband property of the PMI, the plurality of second parameters are associated with wideband property of the PMI or subband property of the PMI, and the plurality of third parameters are associated with wideband property of the PMI or subband property of the PMI.

5. The method of claim 3, further comprising:
transmitting, by the processor, a size of a frequency block for determining the plurality of second parameters or the plurality of third parameters for subband property of the PMI.

6. The method of claim 1, wherein the plurality CSI-RS resources are associated with a plurality of transmission reception points (TRPs), a plurality of antenna panels, or a plurality of antenna port groups.

7. The method of claim 1, further comprising:
transmitting, by the processor, a number of signal source groups N_{g}, wherein each signal source group is associated with at least one port of the plurality of CSI-RS resources for determining the matrix W_{D}.

8. A method, comprising:
transmitting, by a processor of an apparatus, a plurality of channel state information reference signal (CSI-RS) resources for determining a precoding matrix indicator (PMI), wherein the PMI corresponds to a precoding matrix W, the precoding matrix W is a product of matrices W_{D} and W_{P}, the matrix W_{D} is a block diagonal matrix diag{W₁, . . . , W_{N}_{_{g}}}, each block matrix Wₖ of the block diagonal matrix is associated with one of the plurality of CSI-RS resources, and the matrix W_{P} is an inter-resource phase compensation matrix; and
receiving, by the processor, a CSI report including the PMI.

9. The method of claim 8, wherein the PMI further comprises a plurality of first parameters and a plurality of second parameters, associated with the plurality of CSI-RS resources respectively, to indicate the matrix Wₖ, the first parameters indicate Discrete Fourier Transform (DFT) indices of selected spatial domain (SD) bases of the matrix Wₖ, the second parameters indicate inter-polarization co-phase information of the matrix Wₖ, and the first parameters and second parameters are determined respectively for the plurality of CSI-RS resources.

10. The method of claim 9, wherein the PMI further comprises a plurality of third parameters, the matrix W_{P} matrix consists of a plurality of inter-resource phase terms, the plurality of third parameters are independently determined to indicate the plurality of inter-resource phase terms with respect to a first resource of the plurality of CSI-RS resources.

11. The method of claim 10, wherein the plurality of first parameters are associated with wideband property of the PMI, the plurality of second parameters are associated with wideband property of the PMI or subband property of the PMI, and the plurality of third parameters are associated with wideband property of the PMI or subband property of the PMI.

12. The method of claim 11, further comprising:
receiving, by the processor, a size of a frequency block for determining the plurality of second parameters or the plurality of third parameters for subband property of the PMI.

13. The method of claim 8, wherein the plurality CSI-RS resources are associated with a plurality of transmission reception points (TRPs), a plurality of antenna panels, or a plurality of antenna port groups.

14. The method of claim 8, further comprising:
receiving, by the processor, a number of signal source groups N_{g}, wherein each signal source group is associated with at least one port of the plurality of CSI-RS resources for determining the matrix W_{D}.

15. An apparatus, comprising:
a transceiver which, during operation, wirelessly communicates with a wireless network; and
a processor communicatively coupled to the transceiver such that, during operation, the processor performs operations comprising:
receiving, via the transceiver, a plurality of channel state information reference signal (CSI-RS) resources;
determining a precoding matrix indicator (PMI), wherein the PMI corresponds to a precoding matrix W, the precoding matrix W is a product of matrices W_{D} and W_{P}, the matrix W_{D} is a block diagonal matrix diag{W₁, . . . , W_{N}_{_{g}}}, each block matrix Wₖ of the block diagonal matrix is associated with one of the plurality of CSI-RS resources, and the matrix W_{P} is an inter-resource phase compensation matrix; and
transmitting, via the transceiver, a CSI report including the PMI.

16. The apparatus of claim 15, wherein the PMI further comprises a plurality of first parameters and a plurality of second parameters, associated with the plurality of CSI-RS resources respectively, to indicate the matrix Wₖ; the first parameters indicate Discrete Fourier Transform (DFT) indices of selected spatial domain (SD) bases of the matrix Wₖ, the second parameters indicate inter-polarization co-phase information of the matrix Wₖ; and the first parameters and second parameters are determined respectively for the plurality of CSI-RS resources.

17. The apparatus of claim 16, wherein the PMI further comprises a plurality of third parameters, the matrix W_{P} matrix consists of a plurality of inter-resource phase terms, the plurality of third parameters are independently determined to indicate the plurality of inter-resource phase terms with respect to a first resource of the plurality of CSI-RS resources.

18. The apparatus of claim 17, wherein the plurality of first parameters are associated with wideband property of the PMI, the plurality of second parameters are associated with wideband property of the PMI or subband property of the PMI, and the plurality of third parameters are associated with wideband property of the PMI or subband property of the PMI.

19. The apparatus of claim 17, wherein, during operation, the processor further performs operation comprising:
transmitting, by the transceiver, a size of a frequency block for determining the plurality of second parameters or the plurality of third parameters for subband property of the PMI.

20. The apparatus of claim 15, wherein, during operation, the transmitting further performs operation comprising:
receiving, via the processor, a number of signal source groups N_{g}, wherein each signal source group is associated with at least one port of the plurality of CSI-RS resources for determining the matrix W_{D}.
